(19) United States
(12) Patent Application Publication
(10) Pub. No.: US 2024/0294393 A1
(43) Pub. Date: Sep. 5, 2024

(54) PLATE-SHAPED IRON OXIDE PARTICLES AND METHOD FOR PRODUCING IRON OXIDE PARTICLES

(71) Applicant: DIC Corporation, Tokyo (JP)

(72) Inventors: Meng LI, Shandong (CN); Naoto YAGI, Chiba (JP); Jianjun YUAN, Chiba (JP); Shaowei YANG, Shandong (CN); Wei ZHAO, Shandong (CN); Jian GUO, Shandong (CN); Xuan LI, Shandong (CN)

(73) Assignee: DIC Corporation, Tokyo (JP)

(21) Appl. No.: 18/574,719

(22) PCT Filed: Jul. 2, 2021
(86) PCT No.: PCT/CN2021/104340

§ 371 Date: Dec. 27, 2023

(51) Int. Cl. C01G 49/06; C01G 49/00

(52) U.S. Cl. CPC C01G 49/06; C01G 49/0018; C01P 2002/50; C01P 2002/72; C01P 2004/03; C01P 2004/04; C01P 2004/20; C01P 2004/54; C01P 2004/62; C01P 2004/64; C01P 2006/12

(57) ABSTRACT

The present invention relates to plate-shaped iron oxide particles containing molybdenum and atoms derived from a shape control agent. The present invention relates to a method for producing the plate-shaped iron oxide particles, the method including a calcination step of calcining an iron compound in the presence of a molybdenum compound and a shape control agent.

### TECHNICAL FIELD

The present invention relates to plate-shaped iron oxide particles and a method for producing the plate-shaped iron oxide particles.

### BACKGROUND

Iron oxide is widely used as material for pigments and it is known that hematite (α-Fe₂O₃) exhibits a reddish color, magnetite (Fe₃O₄) exhibits a blackish color, and maghemite (γ-Fe₂O₃) exhibits a dark brown color depending on a difference in crystal structure. Magnetite and hematite, which take advantage of magnetic characteristics, are used in materials for wave absorbers, noise suppression, high magnetic permeability materials, magnetic toner, magnetic recording, and the like in addition to applications for pigment materials.

For example, PTL 1 discloses that flake-shaped iron oxide microparticles which contain silicon and magnesium and which have a particle size of 0.01 μm to 100 μm and an aspect ratio of 3 to 200 are obtained by the hydrothermal reaction of an iron hydroxide-containing aqueous solution doped with silicon and magnesium.

PTL 2 discloses that a black pigment containing iron oxide microparticles having an average particle size of 50 nm to 120 nm and an Fe₃O₄ crystal structure is obtained in such a manner that, after red-brown iron oxide microparticles having a γ-Fe₂O₃ crystal structure are produced by a direct-current arc plasma method using an iron source material as a consumptive anodic electrode, the iron oxide microparticles are calcined in a reducing atmosphere.

PTL 3 discloses that iron oxide magnetic nanoparticles which are made of single-phase ε-Fe₂O₃ and which have an average particle size of 15 nm or less are obtained in such a manner that, after β-FeO(OH) nanoparticles are coated with silicon oxide, the silicon oxide-coated β-FeO(OH) nanoparticles are heat-treated in an oxidizing atmosphere.

### CITATION LIST

### Patent Literature

PTL 1: Japanese Unexamined Patent Application Publication No. 2008-254969
PTL 2: Japanese Unexamined Patent Application Publication No. 2002-104828
PTL 3: Japanese Unexamined Patent Application Publication No. 2014-224027

### SUMMARY

### Technical Problem

However, there is still room to study plate-shaped iron oxide particles and methods for producing the same.

An object of the present invention is to provide plate-shaped iron oxide particles having excellent characteristics and a method for producing the same.

### Solution to Problem

The present invention includes aspects below.

(1) Plate-shaped iron oxide particles containing molybdenum and atoms derived from a shape control agent.

(2) In the plate-shaped iron oxide particles specified in Item (1), the plate-shaped iron oxide particles have a median diameter D₅₀ of 0.01 μm to 0.5 μm as determined by a dynamic light scattering method.

(3) In the plate-shaped iron oxide particles specified in Item (1) or (2), an aspect ratio obtained by dividing an average particle size of primary particles by a thickness thereof is 5 to 500.

(4) In the plate-shaped iron oxide particles specified in any one of Items (1) to (3), the primary particles have an average particle size of 0.01 to 0.5 μm and a thickness of less than 0.05 μm.

(5) In the plate-shaped iron oxide particles specified in any one of Items (1) to (4), a Fe₂O₃ content (F₁) of the plate-shaped iron oxide particles is 85.0% by mass to 99.5% by mass as determined by X-ray fluorescence (XRF) analysis of the plate-shaped iron oxide particles, and a MoO₃ content (M₁) of the plate-shaped iron oxide particles is 0.01% by mass to 5.0% by mass as determined by XRF analysis of the plate-shaped iron oxide particles.

(6) In the plate-shaped iron oxide particles specified in any one of Items (1) to (5), the atoms derived from a shape control agent are at least one kind selected from the group consisting of silicon, germanium, and phosphorus.

(7) In the plate-shaped iron oxide particles specified in any one of Items (1) to (6), the atoms derived from a shape control agent are unevenly distributed in a surface layer of each of the plate-shaped iron oxide particles.

(8) In the plate-shaped iron oxide particles specified in any one of Items (1) to (7), the atoms derived from a shape control agent are silicon.

(9) In the plate-shaped iron oxide particles specified in Item (8), a Fe₂O₃ content (F₁) of the plate-shaped iron oxide particles is 85.0% by mass to 99.5% by mass as determined by XRF analysis of the plate-shaped iron oxide particles, a MoO₃ content (M₁) of the plate-shaped iron oxide particles is 0.01% by mass to 5.0% by mass as determined by XRF analysis of the plate-shaped iron oxide particles, and a SiO₂ content (S₁) of the plate-shaped iron oxide particles is 0.001% by mass to 10% by mass as determined by XRF analysis of the plate-shaped iron oxide particles.

(10) In the plate-shaped iron oxide particles specified in Item (8) or (9), a surface uneven distribution ratio (S₂/S₁) of a SiO₂ content (S₂) of a surface layer of each of the plate-shaped iron oxide particles as determined by X-ray photoelectron spectroscopy (XPS) surface analysis of the plate-shaped iron oxide particle to a SiO₂ content (S₁) of the plate-shaped iron oxide particle as determined by XRF analysis of the plate-shaped iron oxide particle is more than 1 and 20 or less.

(11) In the plate-shaped iron oxide particles specified in any one of Items (1) to (10), the plate-shaped iron oxide particles have a specific surface area of 0.5 m²/g or more as determined by a BET method.

(12) A method for producing the plate-shaped iron oxide particles specified in any one of Items (1) to (11) includes a calcination step of calcining an iron compound in presence of a molybdenum compound and a shape control agent.

(13) In the method for producing the plate-shaped iron oxide particles specified in Item (12), the shape control agent is silicon or a silicon compound.

(14) The method for producing the plate-shaped iron oxide particles specified in Item (12) or (13) includes a precursor producing step of obtaining nanosized particles of the iron compound, prior to the calcination step.

(15) In the method for producing the plate-shaped iron oxide particles specified in any one of Items (12) to (14), the molybdenum compound in the calcination step is at least one kind selected from the group consisting of molybdenum trioxide, lithium molybdate, potassium molybdate, and sodium molybdate.

(16) In the method for producing the plate-shaped iron oxide particles specified in any one of Items (12) to (15), the iron compound is calcined at a calcination temperature of 400° C. or higher and lower than 1000° C.

### Advantageous Effects of Invention

The present invention provides plate-shaped iron oxide particles having excellent characteristics and a method for producing the same.

### BRIEF DESCRIPTION OF DRAWINGS

FIG. 1 is a SEM photograph of plate-shaped iron oxide particles obtained in Example 1.

FIG. 2 is a SEM photograph of plate-shaped iron oxide particles obtained in Example 2.

FIG. 3 is a SEM photograph of plate-shaped iron oxide particles obtained in Example 3.

FIG. 4 is a SEM photograph of plate-shaped iron oxide particles obtained in Reference Example 1.

FIG. 5 is a TEM photograph of plate-shaped iron oxide particles obtained in Example 1.

FIG. 6 is a TEM photograph of plate-shaped iron oxide particles obtained in Example 2.

FIG. 7 is a TEM photograph of plate-shaped iron oxide particles obtained in Example 3.

FIG. 8 is a graph illustrating X-ray diffraction (XRD) patterns of the plate-shaped iron oxide particles obtained in Examples.

FIG. 9 is a diagram for explaining an exemplary method for producing plate-shaped iron oxide particles according to an embodiment of the present invention.

### DESCRIPTION OF EMBODIMENTS

Embodiments of plate-shaped iron oxide particles and a method for producing plate-shaped iron oxide particles according to the present invention will be described below.

### [Plate-Shaped Iron Oxide Particles]

Plate-shaped iron oxide particles according to an embodiment contain molybdenum and atoms derived from a shape control agent. The plate-shaped iron oxide particles contain molybdenum and have excellent characteristics such as catalytic activity derived from molybdenum.

The plate-shaped iron oxide particles may contain molybdenum derived from a molybdenum compound used in a production method described later.

The plate-shaped iron oxide particles may further contain atoms derived from a shape control agent. The plate-shaped iron oxide particles may contain atoms derived from a shape control agent in the production method described later. The shape control agent plays an important role in plate-shaped crystal growth.

The median diameter D₅₀ of the plate-shaped iron oxide particles is preferably 0.01 μm to 0.5 μm, more preferably 0.05 μm to 0.45 μm, and further more preferably 0.1 μm to 0.4 μm as determined by a dynamic light scattering method.

The particle size D₁₀ of the plate-shaped iron oxide particles is preferably 0.005 μm to 0.3 μm, more preferably 0.01 μm to 0.25 μm, and further more preferably 0.05 μm to 0.3 μm as determined by the dynamic light scattering method.

The particle size D₉₀ of the plate-shaped iron oxide particles is preferably 0.1 μm to 5 μm, more preferably 0.3 μm to 4.5 μm, and further more preferably 0.4 m to 4 μm as determined by the dynamic light scattering method.

The median diameter D₅₀, the particle size D₁₀, and the particle size D₉₀ of the plate-shaped iron oxide particles are determined by the dynamic light scattering method. Specifically, for example, they can be obtained by measuring a particle size distribution in a wet mode using water as a dispersion medium using a dynamic light scattering particle size measurement apparatus (for example, NANOTRAC WAVE II available from MicrotracBEL Corporation).

The median diameter D₅₀ of the plate-shaped iron oxide particle sample as determined by the dynamic light scattering method can be obtained as a particle size at a cumulative volume percentage of 50% in the particle size distribution measured in a wet mode using a dynamic light scattering particle size measurement apparatus. The particle size D₁₀ can be obtained as a particle size at a cumulative volume percentage of 10% from the smallest particles. The particle size D₉₀ can be obtained as a particle size at a cumulative volume percentage of 90% from the smallest particles.

As illustrated by the examples described later, the method for producing plate-shaped iron oxide particles according to an embodiment can easily produce nanosized plate-shaped iron oxide particles containing molybdenum. In the present description, “nanosized” refers to a particle size with D₅₀ of less than 1 μm, for example, 0.01 μm to 0.5 km.

The average particle size of primary particles of the plate-shaped iron oxide particles may be 0.01 μm to 0.5 μm, 0.05 μm to 0.45 μm, or 0.1 μm to 0.4 μm.

The average particle size of primary particles of the plate-shaped iron oxide particles is the average of the maximum lengths of the distances between two points on the contour of randomly selected 50 primary particles as determined in such a manner that the iron oxide particles are photographed with a scanning electron microscope (SEM) and the smallest unit particles (that is, the primary particles) forming agglomerates on a two-dimensional image are measured for the distance between two points.

The thickness of primary particles of the plate-shaped iron oxide particles may be less than 0.05 μm, 0.001 μm to 0.05 μm, 0.002 μm to 0.025 μm, or 0.003 μm to 0.01 μm.

The thickness of primary particles of the plate-shaped iron oxide particles is the average of the thicknesses of randomly selected 50 primary particles as determined in such a manner that the iron oxide particles are photographed with a scanning electron microscope (SEM) and the smallest unit particles (that is, the primary particles) forming agglomerates on a two-dimensional image are measured for the thickness.

In the present description, “plate-shaped” means that the aspect ratio obtained by dividing the average particle size of primary particles of the iron oxide particles by the thickness is 3 or more. The aspect ratio of each primary particle of the plate-shaped iron oxide particles is preferably 5 to 500, more preferably 20 to 300, and further more preferably 30 to 100.

It is preferable that the aspect ratio is the above lower limit value or higher, because if so, satisfactory two-dimensional characteristics can be achieved. It is preferable that the aspect ratio is the above upper limit value or lower, because if so, high mechanical strength can be achieved.

The plate-shaped iron oxide particles contain iron oxide. Examples of the iron oxide that may be contained in the plate-shaped iron oxide particles include Fe₂O₃, Fe₃O₄, and FeO. The iron oxide may be hematite (α-Fe₂O₃), magnetite (Fe₃O₄), or maghemite (γ-Fe₂O₃).

The iron content in the plate-shaped iron oxide particles can be measured by XRF analysis. In the plate-shaped iron oxide particles, the Fe₂O₃ content (F₁) of the plate-shaped iron oxide particles is preferably 85.0% by mass to 99.5% by mass, more preferably 87.0% by mass to 99.3% by mass, and further more preferably 89.0% by mass to 99.0% by mass as determined by the XRF analysis of the plate-shaped iron oxide particles.

The plate-shaped iron oxide particles contain molybdenum. In the plate-shaped iron oxide particles, the MoO₃ content (M₁) of the plate-shaped iron oxide particles is preferably 0.01% by mass to 5.0% by mass, more preferably 0.05% by mass to 3.0% by mass, and further more preferably 0.1% by mass to 2.0% by mass as determined by the XRF analysis of the plate-shaped iron oxide particles.

The respective upper limit values and the respective lower limit values of the Fe₂O₃ content (F₁) and the MoO₃ content (M₁) illustrated above in the plate-shaped iron oxide particles can be combined freely. The values of the Fe₂O₃ content (F₁) and the MoO₃ content (M₁) can also be combined freely.

As an example of the plate-shaped iron oxide particles, the plate-shaped iron oxide particles have an Fe₂O₃ content (F₁) of 85.0% by mass to 99.5% by mass and a MoO₃ content (M₁) of 0.01% by mass to 5.0% by mass.

The plate-shaped iron oxide particles contain atoms derived from a shape control agent. It is preferable that the atoms derived from a shape control agent are preferably at least one kind selected from the group consisting of silicon, germanium, and phosphorus. It is more preferable that the atoms derived from a shape control agent are silicon.

The plate-shaped iron oxide particles may contain silicon. The silicon content of the plate-shaped iron oxide particles is such that the SiO₂ content (S₁) of the plate-shaped iron oxide particles is preferably 10% by mass or less, more preferably 0.001% by mass to 10% by mass, further more preferably 0.01% by mass to 7% by mass, and particularly preferably 0.1% by mass to 5% by mass as determined by the XRF analysis of the plate-shaped iron oxide particles.

The respective upper limit values and the respective lower limit values of the Fe₂O₃ content (F₁), the MoO₃ content (M₁), and the SiO₂ content (S₁) illustrated above in the plate-shaped iron oxide particles can be combined freely. The values of the Fe₂O₃ content (F₁), the MoO₃ content (M₁), and the SiO₂ content (S₁) can also be combined freely.

As an example of the plate-shaped iron oxide particles, the plate-shaped iron oxide particles have an Fe₂O₃ content (F₁) of 85.0% by mass to 99.5% by mass, a MoO₃ content (M₁) of 0.01% by mass to 5.0% by mass, and a SiO₂ content (S₁) of 0.001% by mass to 10% by mass.

The Fe₂O₃ content (F₁), the MoO₃ content (M₁), and the SiO₂ content (S₁) can be measured by XRF analysis using an X-ray fluorescence analyzer (for example, Primus IV available from Rigaku Corporation).

The iron content in a surface layer of each plate-shaped iron oxide particle can be measured by X-ray photoelectron spectroscopy (XPS) surface analysis. In the plate-shaped iron oxide particles, the Fe₂O₃ content (F₂) of the surface layer of each plate-shaped iron oxide particle is preferably 60% by mass to 95% by mass, more preferably 65% by mass to 93% by mass, and further more preferably 70% by mass to 90% by mass as determined by the XPS surface analysis of the plate-shaped iron oxide particle.

In the plate-shaped iron oxide particles, the MoO₃ content (M₂) of the surface layer of each plate-shaped iron oxide particle is preferably 0.05% by mass to 20% by mass, more preferably 0.1% by mass to 15% by mass, and further more preferably 0.5% by mass to 10% by mass as determined by the XPS surface analysis of the plate-shaped iron oxide particle.

The respective upper limit values and the respective lower limit values of the Fe₂O₃ content (F₂) and the MoO₃ content (M₂) illustrated above in the plate-shaped iron oxide particles can be combined freely. The values of the Fe₂O₃ content (F₂) and the MoO₃ content (M₂) can also be combined freely.

As an example of the plate-shaped iron oxide particles, the plate-shaped iron oxide particles have an Fe₂O₃ content (F₂) of 60% by mass to 95% by mass and a MoO₃ content (M₂) of 0.05% by mass to 20% by mass.

The surface layer of each plate-shaped iron oxide particle may contain silicon. The inclusion of silicon can improve the dispersibility of the plate-shaped iron oxide particles. In the plate-shaped iron oxide particles, the SiO₂ content (S₂) of the surface layer of each plate-shaped iron oxide particle is preferably 0.1% by mass to 20% by mass, more preferably 0.5% by mass to 18% by mass, and further more preferably 1% by mass to 15% by mass as determined by the XPS surface analysis of the plate-shaped iron oxide particle.

The respective upper limit values and the respective lower limit values of the Fe₂O₃ content (F₂), the MoO₃ content (M₂), and the SiO₂ content (S₂) illustrated above in the plate-shaped iron oxide particles can be combined freely. The values of the Fe₂O₃ content (F₂), the MoO₃ content (M₂), and the SiO₂ content (S₂) can also be combined freely.

As an example of the plate-shaped iron oxide particles, the plate-shaped iron oxide particles have an Fe₂O₃ content (F₂) of 60% by mass to 95% by mass, a MoO₃ content (M₂) of 0.05% by mass to 20% by mass, and a SiO₂ content (S₂) of 0.1% by mass to 20% by mass.

The term “Fe₂O₃ content (F₂)” refers to a value that is determined in such a manner that the abundance (atomic percent) of each element is obtained by the XPS surface analysis of the plate-shaped iron oxide particle sample by X-ray photoelectron spectroscopy (XPS) and the content of Fe₂O₃ in the surface layer of the plate-shaped iron oxide particle is determined by converting the content of iron into the content of iron oxide.

The term “MoO₃ content (M₂)” refers to a value that is determined in such a manner that the abundance (atomic percent) of each element is obtained by the XPS surface analysis of the plate-shaped iron oxide particle by X-ray photoelectron spectroscopy and the content of MoO₃ in the surface layer of the plate-shaped iron oxide particle is determined by converting the content of molybdenum into the content of molybdenum trioxide.

The term “SiO₂ content (S₂)” refers to a value that is determined in such a manner that the abundance (atomic percent) of each element is obtained by the XPS surface analysis of the plate-shaped iron oxide particle by X-ray photoelectron spectroscopy and the content of SiO₂ in the surface layer of the plate-shaped iron oxide particle is determined by converting the content of silicon into the content of silicon dioxide.

In the plate-shaped iron oxide particles, it is preferable that the molybdenum is unevenly distributed in the surface layer of each plate-shaped iron oxide particle.

The term “surface layer” in the present description refers to a portion within 10 nm from the surface of the plate-shaped iron oxide particle. This distance corresponds to the depth detected by XPS used for measurement in an example.

The expression “unevenly distributed in a surface layer” as used herein refers to a state that, for example, in the case of molybdenum, the mass of molybdenum or a molybdenum compound in the surface layer per unit volume is larger than the mass of molybdenum or the molybdenum compound in a portion other than the surface layer per unit volume.

In the plate-shaped iron oxide particles, the uneven distribution of molybdenum in the surface layer of each plate-shaped iron oxide particle can be confirmed by the fact that the MoO₃ content (M₂) of the surface layer of the plate-shaped iron oxide particle as determined by the XPS surface analysis of the plate-shaped iron oxide particle is higher than the MoO₃ content (M₁) of the plate-shaped iron oxide particle as determined by the X-ray fluorescence (XRF) analysis of the plate-shaped iron oxide particle, as illustrated by examples described later.

In the plate-shaped iron oxide particles, as an indicator of the uneven distribution of molybdenum in the surface layer of each plate-shaped iron oxide particle, the ratio of the MoO₃ (M₂) content to the MoO₃ (M₁) content of the plate-shaped iron oxide particle, that is, the surface uneven distribution ratio (M₂/M₁) is preferably more than 1 and 20 or less, more preferably 1.1 to 10, and further more preferably 1.5 to 5.

The uneven distribution of molybdenum or the molybdenum compound in the surface layer efficiently imparts excellent characteristics such as catalytic activity, as compared to the even presence of molybdenum or the molybdenum compound not only in the surface layer but also in a portion (an inner layer) other than the surface layer.

In the plate-shaped iron oxide particles, it is preferable that the atoms derived from a shape control agent are unevenly distributed in the surface layer of each plate-shaped iron oxide particle, and it is more preferable that silicon or a silicon compound is unevenly distributed in the surface layer of each plate-shaped iron oxide particle.

In the plate-shaped iron oxide particles, as an indicator of the uneven distribution of silicon or the silicon compound in the surface layer of each plate-shaped iron oxide particle, the ratio of the SiO₂ (S₂) content to the SiO₂ (S₁) content of the plate-shaped iron oxide particle, that is, the surface uneven distribution ratio (S₂/S₁) is preferably more than 1 and 20 or less, more preferably 1.1 to 10, and further more preferably 1.5 to 5.

The uneven distribution of silicon or the silicon compound in the surface layer efficiently imparts excellent characteristics such as improved dispersibility in water, as compared to the even presence of silicon or the silicon compound not only in the surface layer but also in a portion (an inner layer) other than the surface layer.

The plate-shaped iron oxide particles may further contain lithium, potassium, or sodium, in addition to molybdenum and the atoms derived from a shape control agent listed above.

The plate-shaped iron oxide particles are such that the pH of the isoelectric point at which the potential is 0 (zero) as determined by zeta potential measurement is shifted to the acidic side as compared to usual plate-shaped iron oxide particles because molybdenum is unevenly distributed in the surface layer of each iron oxide particle.

The pH of the isoelectric point at which the potential of the plate-shaped iron oxide particles is 0 (zero) is within the range of, for example, 2 to 5 and is preferably within the range of 2.3 to 4.5 and more preferably 2.5 to 4. When the pH of the isoelectric point is within the above range, the plate-shaped iron oxide particles have high electrostatic repulsion and the dispersion stability of the iron oxide particles blended with a dispersion medium can be increased.

The specific surface area of the plate-shaped iron oxide particles may be 0.5 m²/g or more, 1 m²/g or more, 5 m²/g or more, or 10 m²/g or more as determined by the BET (Brunauer-Emmett-Teller) method.

The specific surface area of the plate-shaped iron oxide particles may be 150 m²/g or less, 100 m²/g or less, 75 m²/g or less, or 50 m²/g or less as determined by the BET method.

The specific surface area of the plate-shaped iron oxide particles may be 0.5 m²/g to 150 m²/g, 1 m²/g to 100 m²/g, 5 m²/g to 75 m²/g, or 10 m²/g to 50 m²/g as determined by the BET method.

The plate-shaped iron oxide particles contain molybdenum and have excellent characteristics such as catalytic activity derived from molybdenum.

In particular, the plate-shaped iron oxide particles, which have an extremely small particle size as exemplified by the values of the median diameter D₅₀ or the average particle size above, have characteristics of high dispersibility in a dispersion liquid. The characteristics of a high aspect ratio and a large BET specific surface area as exemplified by the values of the aspect ratio and the BET specific surface area above also improve the dispersibility of the plate-shaped iron oxide particles. With such plate-shaped iron oxide particles, a composition in which the plate-shaped iron oxide particles are homogeneously dispersed can be obtained.

### [Method for Producing Plate-Shaped Iron Oxide Particles]

The method for producing plate-shaped iron oxide particles according to an embodiment includes a calcination step of calcining an iron compound in the presence of the molybdenum compound and the shape control agent. More specifically, the method may include a mixing step of mixing the iron compound, the molybdenum compound, and the shape control agent into a mixture and a calcination step of calcining the mixture.

The shape control agent is preferably at least one kind selected from the group consisting of silicon (silicon atom and/or silicon compound), germanium (germanium atom and/or germanium compound), and phosphorus (phosphorus atom and/or phosphorus compound), and the shape control agent is more preferably silicon or a silicon compound.

From the view point of capable of readily producing plate-shaped iron oxide particles with a high aspect ratio and a small particle size, the iron compound to be calcined is preferably nanosized particles of the iron compound, more preferably nanosized particles of iron oxide. The nanosized particles of the iron compound can be obtained, for example, in a precursor producing step described below.

The molybdenum compound to be calcined is preferably nanosized particles of the molybdenum compound, more preferably nanosized particles of molybdenum oxide, in the same manner as the iron compound. The nanosized particles of the molybdenum compound can be obtained, for example, in the precursor producing step described below.

The shape of the shape control agent is not limited. It is preferable that the shape control agent is nanosized particles because if so, the state of mixing with the iron compound becomes homogeneous and the plate shape of the iron oxide particles can be effectively controlled.

When the shape control agent is silicon or the silicon compound, the shape of silicon or the silicon compound is not limited. Silicon or the silicon compound is preferably nanosized particles of silicon or the silicon compound, more preferably nanosized particles of silicon oxide, because if so, the state of mixing with the iron compound becomes homogeneous and the plate shape of the iron oxide particles can be effectively controlled.

It is preferable that the method for producing plate-shaped iron oxide particles includes a calcination step of calcining the nanosized iron compound in the presence of the molybdenum compound and the shape control agent.

It is preferable that the method for producing plate-shaped iron oxide particles includes a calcination step of calcining the nanosized iron compound in the presence of the molybdenum compound and silicon or the silicon compound.

It is more preferable that the method for producing plate-shaped iron oxide particles includes a calcination step of calcining the nanosized iron compound in the presence of the nanosized molybdenum compound and the nanosized silicon or silicon compound.

The particle size of the nanosized particles of the iron compound, the molybdenum compound, and the shape control agent is, for example, the value exemplified by the median diameter D₅₀ of the plate-shaped iron oxide particles.

With the method for producing plate-shaped iron oxide particles, the plate-shaped iron oxide particles having a shape controlled to a plate shape can be produced.

### [Precursor Producing Step]

The inventors of the present invention have found that plate-shaped iron oxide particles with a high aspect ratio and with a small particle size can be readily produced by obtaining nanosized particles of an iron compound in the following precursor producing step and using the obtained particles as the iron compound to be calcined.

The method for producing plate-shaped iron oxide particles preferably includes a precursor producing step of obtaining nanosized particles of the iron compound, prior to the calcination step.

The method for producing plate-shaped iron oxide particles preferably includes a precursor producing step of mixing a solution of an iron salt into an acid solution to obtain particles of the iron compound, prior to the calcination step.

The method for producing plate-shaped iron oxide particles preferably includes a precursor producing step of mixing a solution of an iron salt into an acid solution and mixing a solution of a molybdate into the acid solution to obtain particles of the iron compound and particles of the molybdenum compound, prior to the calcination step. The produced particles of the molybdenum compound can be used as a flux agent raw material in the subsequent calcination step.

Examples of the iron salt include iron halide, iron sulfide, iron sulfate, and iron nitrate, and iron halide is preferred. Examples of the iron halide include iron(III) chloride (FeCl₃), iron(II) chloride (FeCl₂), iron(III) bromide (FeBr₃), iron(II) bromide (FeBr₂), iron(III) fluoride (FeF₃), iron(II) fluoride (FeF₂), iron(III) iodide (FeI₃), and iron(II) iodide (FeI₂). The iron salt may be a hydrate.

Examples of the molybdate include salts of molybdenum oxoanions such as MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄⁶⁻, and Mo₈O₂₆⁴⁻. The molybdate may be an alkali metal salt, alkaline-earth metal salt, or ammonium salt of the molybdenum oxoanion.

The molybdate is preferably an alkali metal salt of a molybdenum oxoanion, more preferably lithium molybdate, potassium molybdate, or sodium molybdate, and further more preferably potassium molybdate or sodium molybdate. The molybdate may be a hydrate.

In the precursor producing step, a solution of iron halide and a solution of an alkali metal salt of a molybdenum oxoanion are preferably used, a solution of iron halide and a solution of potassium molybdate or sodium molybdate are more preferably used, and a solution of iron chloride and a solution of sodium molybdate are further more preferably used as an exemplary combination of the iron salt and the molybdate.

A method of mixing the solution of iron salt and the solution of molybdate into the acid solution is not limited. It is preferable that the solution of iron salt and the solution of molybdate are instilled into the acid solution.

From the viewpoint of preventing aggregation of particles of the iron compound and particles of the molybdenum compound, it is preferable that the acid solution into which the solution of iron salt and/or the solution of molybdate is instilled is stirred. The degree of the stirring is, for example, 50 to 1000 rpm.

The pH of the acid solution may be lower than 7, may be 1 to 5, or 2 to 4.

The particles of the iron compound and the particles of the molybdenum compound can be readily recovered by drying the mixture of the acid solution and the solution of iron salt and/or the mixture of the acid solution and the solution of molybdate and removing volatile components.

Mixing of the solution of iron salt into the acid solution presumably allows iron salt in the iron salt solution to be hydrolyzed into iron hydroxide, which is dried into iron oxide, whereby nanosized particles of the iron compound are deposited. Mixing of the solution of molybdate into the acid solution presumably allows molybdate in the molybdate solution to be hydrolyzed into molybdenum trioxide, whereby nanosized particles of the molybdenum compound are deposited. The nanosized particles of the iron compound are, for example, particles of iron oxide. The nanosized particles of the molybdenum compound are, for example, particles of molybdenum trioxide.

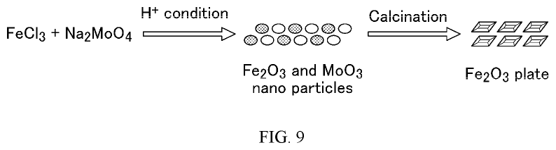

FIG. 9 is a diagram for explaining an example of the method for producing plate-shaped iron oxide particles. Here, FeCl₃ is used as the iron salt and Na₂MoO₄ is used as the molybdate to obtain nanosized Fe₂O₃ particles (particles of the iron compound) and MoO₃ particles (particles of the molybdenum compound). The nanosized particles of the iron compound and the nanosized particles of the molybdenum compound obtained in the precursor producing step need not have a plate shape.

### [Mixing Step]

The method for producing plate-shaped iron oxide particles preferably includes a step of mixing the iron compound, the molybdenum compound, and the shape control agent into a mixture (a mixing step) and a step of calcining the mixture (calcination step).

The method for producing plate-shaped iron oxide particles more preferably includes a step of mixing the iron compound, the molybdenum compound, and silicon or the silicon compound into a mixture (a mixing step) and a step of calcining the mixture (calcination step).

In the example of the production method illustrated in FIG. 9, a mixture of nanosized Fe₂O₃ particles (iron compound) and nanosized MoO₃ particles (molybdenum compound) is obtained in the precursor producing step. The shape control agent (for example, silicon or the silicon compound) is added to this mixture, and the Fe₂O₃ particles (iron compound) is calcined in the presence of MoO₃ particles (molybdenum compound) and silicon or the silicon compound in the subsequent calcination step, whereby plate-shaped crystals of Fe₂O₃ particles are grown, resulting in nanosized plate-shaped Fe₂O₃ particles (plate-shaped iron oxide particles).

### [Iron Compound]

The iron compound is not particularly limited and may be a compound capable of being converted into iron oxide by calcination. The iron compound may be iron oxide, iron oxyhydroxide, or iron hydroxide and is not limited to these compounds. Examples of iron oxide include iron oxide (II) (FeO), which is so-called wustite; iron oxide (II, III) (Fe₃O₄), which is blackish; and iron oxide (III) (Fe₂O₃), which is reddish or red-brown. Examples of iron oxide (III) include α-Fe₂O₃, β-Fe₂O₃, γ-Fe₂O₃, and ε-Fe₂O₃. Examples of iron oxyhydroxide include α-iron oxyhydroxide, β-iron oxyhydroxide, γ-iron oxyhydroxide, and δ-iron oxyhydroxide. Examples of iron hydroxide include iron hydroxide (II) (Fe(OH)₂) and iron hydroxide (III) (Fe(OH)₃). Iron oxide is preferably iron oxide (III) (Fe₂O₃).

### [Molybdenum Compound]

Examples of the molybdenum compound include molybdenum oxide and a molybdate.

Examples of the molybdenum oxide include molybdenum dioxide and molybdenum trioxide. The molybdenum oxide is preferably molybdenum trioxide.

The molybdate is not particularly limited and may be a salt of a molybdenum oxoanion such as MoO₄²⁻, Mo₂O₇²⁻, Mo₃O₁₀²⁻, Mo₄O₁₃²⁻, Mo₅O₁₆²⁻, MoO₁₉²⁻, Mo₇O₂₄⁶⁻, or Mo₈O₂₆⁴⁻. The molybdate may be an alkali metal salt, alkaline-earth metal salt, or ammonium salt of the molybdenum oxoanion.

The molybdate is preferably an alkali metal salt of a molybdenum oxoanion, more preferably lithium molybdate, potassium molybdate, or sodium molybdate, and further more preferably potassium molybdate or sodium molybdate.

In the method for producing the plate-shaped iron oxide particles, the molybdate may be a hydrate.

The molybdenum compound in the calcination step is preferably at least one kind selected from the group consisting of molybdenum trioxide, lithium molybdate, potassium molybdate, and sodium molybdate, and more preferably at least one kind selected from the group consisting of molybdenum trioxide, potassium molybdate, and sodium molybdate.

The method for producing plate-shaped iron oxide particles includes calcining the iron compound in the presence of the molybdenum compound, the shape control agent, and a sodium compound.

The method for producing plate-shaped iron oxide particles includes calcining the iron compound in the presence of the molybdenum compound, silicon or the silicon compound, and the sodium compound.

The method for producing plate-shaped iron oxide particles may include a step of mixing the iron compound, the molybdenum compound, the shape control agent, and the sodium compound into a mixture (mixing step), prior to the calcination step, and may include a step of calcining the mixture (calcination step).

More preferably, the method for producing plate-shaped iron oxide particles may include a step of mixing the iron compound, the molybdenum compound, silicon or the silicon compound, and the sodium compound into a mixture (mixing step), prior to the calcination step, and may include a step of calcining the mixture (calcination step).

Alternatively, the method for producing plate-shaped iron oxide particles may include a step of mixing the iron compound, the shape control agent, and a compound containing molybdenum and sodium into a mixture (mixing step), prior to the calcination step, and may include a step of calcining the mixture (calcination step).

More preferably, the method for producing plate-shaped iron oxide particles may include a step of mixing the iron compound, silicon or the silicon compound, and the compound containing molybdenum and sodium into a mixture (mixing step), prior to the calcination step, and may include a step of calcining the mixture (calcination step).

The compound containing molybdenum and sodium, which is a preferred flux agent, can be produced, for example, in the process of calcination using the molybdenum compound and the sodium compound, which are cheaper and readily available, as raw materials. Here, both of using the molybdenum compound and the sodium compound as flux agents and using the compound containing molybdenum and sodium as a flux agent are regarded as using the molybdenum compound and the sodium compound as flux agents, that is, in the presence of the molybdenum compound and the sodium compound.

The method for producing plate-shaped iron oxide particles includes calcining the iron compound in the presence of the molybdenum compound, the shape control agent, and a potassium compound.

The method for producing plate-shaped iron oxide particles includes calcining the iron compound in the presence of the molybdenum compound, silicon or the silicon compound, and the potassium compound.

The method for producing plate-shaped iron oxide particles may include a step of mixing the iron compound, the molybdenum compound, the shape control agent, and the potassium compound into a mixture (mixing step), prior to the calcination step, and may include a step of calcining the mixture (calcination step).

More preferably, the method for producing plate-shaped iron oxide particles may include a step of mixing the iron compound, the molybdenum compound, silicon or the silicon compound, and the potassium compound into a mixture (mixing step), prior to the calcination step, and may include a step of calcining the mixture (calcination step).

Alternatively, the method for producing plate-shaped iron oxide particles may include a step of mixing the iron compound, the shape control agent, and a compound containing molybdenum and potassium into a mixture (mixing step), prior to the calcination step, and may include a step of calcining the mixture (calcination step).

More preferably, the method for producing plate-shaped iron oxide particles may include a step of mixing the iron compound, silicon or the silicon compound, and the compound containing molybdenum and potassium into a mixture (mixing step), prior to the calcination step, and may include a step of calcining the mixture (calcination step).

The compound containing molybdenum and potassium, which is a preferred flux agent, can be produced, for example, in the process of calcination using the molybdenum compound and the potassium compound, which are cheaper and readily available, as raw materials. Here, both of using the molybdenum compound and the potassium compound as flux agents and using the compound containing molybdenum and potassium as a flux agent are regarded as using the molybdenum compound and the potassium compound as flux agents, that is, in the presence of the molybdenum compound and the potassium compound.

The crystal growth of plate-shaped iron oxide particles to be produced is readily controlled by calcining the iron compound in the presence of the molybdenum compound and the potassium compound or in the presence of the molybdenum compound and the sodium compound. The reason for this is not clear but may be that, for example, K₂MoO₄ and Na₂MoO₄ are stable compounds and less likely to volatilize in the calcination step and therefore are less likely to involve a rapid reaction in the volatilization process and enable the growth of plate-shaped iron oxide particles to be easily controlled.

In the method for producing the plate-shaped iron oxide particles, the molybdenum compound is used as a flux agent. Hereinafter, the production method in which the molybdenum compound is used as a flux agent is simply referred to as the “flux method” in some cases. When, after the molybdenum compound reacts with the iron compound at high temperature during calcination to form iron molybdate, the iron molybdate decomposes into iron oxide and molybdenum oxide at higher temperature, the molybdenum compound can be presumed to be incorporated into the iron oxide particles. Molybdenum oxide sublimates and is removed outside a system and the molybdenum compound reacts with the iron compound in this course, so that the molybdenum compound can be presumed to be formed in the surface layer of each plate-shaped iron oxide particle. In particular, a mechanism of forming the molybdenum compound in the plate-shaped iron oxide particle can be presumed as follows: Mo—O—Fe is formed in the surface layer of the plate-shaped iron oxide particle by the reaction of molybdenum with Fe atoms and high-temperature calcination eliminates Mo and forms molybdenum oxide, a compound containing an Mo—O—Fe bond, or the like in the surface layer of the plate-shaped iron oxide particle.

Molybdenum oxide not incorporated into the plate-shaped iron oxide particle is recovered by sublimation and thereby can be reused. This enables the amount of molybdenum oxide adhering to the surface of the iron oxide particle to be reduced and also enables inherent properties of the plate-shaped iron oxide particle to be optimized.

On the other hand, the alkali metal salt of the molybdenum oxoanion does not vaporize at calcination temperatures and can be readily recovered by washing after calcination. Therefore, the amount of the molybdenum compound released out of a calcination furnace is reduced and production costs can be significantly reduced.

### [Sodium Compound]

The sodium compound is not limited and known sodium compounds may be used. Specific examples of these include sodium carbonate, sodium molybdate, sodium oxide, sodium sulfate, sodium hydroxide, sodium nitrate, sodium chloride, and metallic sodium. Among these, from the viewpoint of industrial easy availability and easiness in handling, sodium carbonate, sodium molybdate, sodium oxide, and sodium sulfate are preferably used. The sodium compounds may be used singly or may be used in combination of two or more kinds.

### [Potassium Compound]

Examples of the potassium compound include, but not limited to, potassium chloride, potassium chlorite, potassium chlorate, potassium sulfate, potassium hydrogen sulfate, potassium sulfite, potassium bisulfite, potassium nitrate, potassium carbonate, potassium bicarbonate, potassium acetate, potassium oxide, potassium bromide, potassium bromate, potassium hydroxide, potassium silicate, potassium phosphate, potassium hydrogen phosphate, potassium sulfide, potassium hydrosulfide, potassium molybdate, and potassium tungstate. In this case, the potassium compound includes isomers thereof, in the same manner as the molybdenum compound. Among these, the potassium compound is preferably at least one kind selected from the group consisting of potassium carbonate, potassium bicarbonate, potassium oxide, potassium hydroxide, potassium chloride, potassium sulfate, and potassium molybdate, and more preferably at least one kind selected from the group consisting of potassium carbonate, potassium bicarbonate, potassium chloride, potassium sulfate, and potassium molybdate. The potassium compounds may be used singly or may be used in combination of two or more kinds.

### [Shape Control Agent]

The shape control agent can be used to form the plate-shaped iron oxide particles. The shape control agent plays a role in inducing or accelerating plate-shaped crystal growth of iron oxide particles in the presence of the molybdenum compound. The shape control agent is, for example, at least one kind selected from the group consisting of silicon (silicon atom and/or silicon compound), germanium (germanium atom and/or germanium compound), and phosphorus (phosphorus atom and/or phosphorus compound).

### [Silicon or Silicon Compound]

Silicon or the silicon compound is not limited and known silicon or silicon compounds may be used. Specific examples of silicon or the silicon compound include artificially synthesized silicon compounds such as metallic silicon, organic silane, silicone resin, silica microparticles, silica gel, mesoporous silica, SiC, and mullite; and natural silicon compounds such as bio silica. Among these, from the view point of capable of more evenly forming combination and mixing with an aluminum compound, organic silane, silicone resin, or silica microparticles are preferably used. Silicon or the silicon compounds may be used singly or may be used in combination of two or more kinds.

### [Germanium or Germanium Compound]

The germanium compound is not limited and known germanium compounds may be used. Specific examples of the germanium compound include germanium metal, germanium dioxide, germanium monoxide, germanium tetrachloride, and organic germanium compounds having a Ge—C bond. The germanium compounds may be used singly or may be used in combination of two or more kinds.

### [Phosphorus or Phosphorus Compound]

The phosphorus compound is not limited and known phosphorus compounds may be used. Specific examples of the phosphorus compound include diphosphorus pentoxide, phosphomolybdic acid, aluminum phosphate, aluminum dihydrogen phosphate, polyphosphoric acid, phosphine, phosphinic acid, and phosphonium salt. The phosphorus compounds may be used singly or may be used in combination of two or more kinds.

When silicon or the silicon compound is used as the shape control agent, in the method for producing plate-shaped iron oxide particles, the amounts of blended iron compound, molybdenum compound, and silicon or silicon compound to be calcined in the calcination step are not limited. It is preferable that 50% by mass or more of the iron compound, 30% by mass or less of the molybdenum compound, and 20% by mass or less of silicon or the silicon compound are mixed into a mixture, which may be calcined. It is more preferable that 50% by mass or more to 98% by mass or less of the iron compound, 1% by mass or more to 30% by mass or less of the molybdenum compound, 0.01% by mass or more to 10% by mass or less of silicon or the silicon compound are mixed into a mixture, which may be calcined. It is further more preferable that 65% by mass or more to 90% by mass or less of the iron compound, 5% by mass or more to 25% by mass or less of the molybdenum compound, 0.1% by mass or more to 5% by mass or less of silicon or the silicon compound are mixed into a mixture, which may be calcined.

In the method for producing plate-shaped iron oxide particles, the molar ratio (Fe/Mo) of iron atoms in the iron compound to be calcined in the calcination step to molybdenum atoms in the molybdenum compound may be 1 or higher and 20 or lower, 2 or higher and 15 or lower, and preferably 3 or higher and 10 or lower.

For example, 0.5 parts by mass to 20 parts by mass, 1 parts by mass to 15 parts by mass, or 3 parts by mass to 10 parts by mass of silicon or the silicon compound per 100 parts by mass of the iron compound may be blended in the mixture to be calcined in the calcination step

For example, 0.5 moles to 50 moles, 0.7 moles to 40 moles, or 1 mole to 10 moles of the sodium compound per 100 moles of the molybdenum compound may be blended in the mixture to be calcined in the calcination step.

Using the compounds within the above ranges allows the amount of the molybdenum compound contained in the obtained plate-shaped iron oxide particles to be appropriate and readily provides the plate-shaped iron oxide particles with the controlled particle size and particle shape.

### [Calcination Step]

The calcination step is a step of calcining the above-mentioned mixture. The plate-shaped iron oxide particles are obtained by calcining the mixture. As described above, the production method is referred to as the flux method.

The flux method is categorized into a solution method. In particular, the flux method is a method for growing a crystal using the fact that a crystal-flux binary phase diagram exhibits a eutectic. A mechanism of the flux method can be presumed as described below. Heating a mixture of a solute and flux allows the solute and the flux to become liquid. In this process, the flux is a fusing agent, that is, a solute-flux binary phase diagram exhibits a eutectic; hence, the solute melts at a temperature lower than the melting point thereof to form a liquid phase. When the flux is vaporized in this state, the concentration of the flux decreases, that is, the effect of reducing the melting point of the solute decreases, so that the crystal growth of the solute occurs as the vaporization of the flux serves as driving force (a flux vaporization method). Incidentally, the solute and the flux can induce the crystal growth of the solute by cooling a liquid phase (an annealing method).

The flux method has merits such as the fact that crystal growth can be induced at a temperature much lower than a melting point, the fact that a crystal structure can be precisely controlled, and the fact that an idiomorphic crystal can be formed.

In the production of the plate-shaped iron oxide particles by the flux method using the molybdenum compound as flux, a mechanism thereof is not necessarily clear but can be presumed as described below. Calcining the iron compound in the presence of the molybdenum compound first forms iron molybdate. In this process, the iron molybdate grows iron oxide crystals at a temperature lower than the melting point of iron oxide as is understood from the above description. Iron molybdate is decomposed by vaporizing, for example, flux and the iron oxide particles can be obtained by crystal growth. That is, the molybdenum compound functions as flux and the iron oxide particles are produced through an intermediate that is iron molybdate.

The shape control agent plays an important role in plate-shaped crystal growth. In a molybdenum oxide flux method, molybdenum oxide reacts with the iron compound to form iron molybdate, and subsequently, change in chemical potential in a decomposition process of the iron molybdate drives crystallization to form iron oxide particles. In the production method according to an embodiment, it is conceivable that localization of the shape control agent near the particle surface in the iron oxide growth process makes the growth in crystal orientation in a plane direction relatively faster and enables formation of the plate shape with a high aspect ratio. Using the molybdenum compound as a flux agent, the plate-shaped iron oxide particles containing molybdenum can be more readily formed.

The mechanism described above is only an assumption, and a mechanism different from the mechanism described above to achieve the effect of the present invention falls within the technical scope of the present invention.

With the flux method, the plate-shaped iron oxide particles containing molybdenum can be readily produced.

A method for calcining the iron compound is not particularly limited and may be a known common method. It is generally conceivable that when the calcination temperature exceeds 650° C., the iron compound reacts with the molybdenum compound to form iron molybdate. It is conceivable that when the calcination temperature is 800° C. or higher, the iron molybdate decomposes to form iron oxide particles. In the iron oxide particles, it is conceivable that when the iron molybdate decomposes into iron and molybdenum oxide, the molybdenum compound is incorporated into the iron oxide particles.

When the iron compound is calcined, the states of the iron compound, the molybdenum compound, and the shape control agent are not particularly limited, and the iron compound, the molybdenum compound, and the shape control agent may be present in the same space such that the molybdenum compound and the shape control agent can act on the iron compound. In particular, a powder of the iron compound, a powder of the molybdenum compound, and a powder of the shape control agent may be simply mixed together, or the iron compound, the molybdenum compound, and the shape control agent may be mechanically mixed together using a crusher or the like, may be mixed together using a mortar or the like, or may be mixed together in a dry or wet state.

Conditions for calcining the iron compound are not particularly limited and may be determined depending on the target particle size of the plate-shaped iron oxide particles, the formation of the molybdenum compound in the plate-shaped iron oxide particles, the shape of the plate-shaped iron oxide particles, and/or the like. The calcination temperature may be 800° C. or higher close to the decomposition temperature of iron molybdate.

When the nanosized particles of the iron compound are used in calcination, the calcination temperature may be 400° C. or higher, 500° C. or higher, or 600° C. or higher.

In general, controlling the shape of plate-shaped iron oxide particles obtained after calcination requires high-temperature calcination at a temperature exceeding 1500° C., which promotes a reaction with iron. This is significantly problematic for industrial use from the viewpoint of a load on a calcination furnace and fuel costs.

According to an embodiment of the present invention, the plate-shaped iron oxide particles can be efficiently formed at low cost under conditions that the maximum calcination temperature at which the iron compound is calcined is 1300° C. or lower.

Since the crystal growth proceeds faster at higher calcination temperatures, the calcination temperature is preferably lower than 1000° C., more preferably 900° C. or lower, and further more preferably 800° C. or lower from the viewpoint of facilitating control of the particle size and readily obtaining plate-shaped iron oxide particles with a small particle size.

The range of calcination temperatures at which the iron compound is calcined in the calcination step may be, for example, 400° C. or higher and lower than 1000° C., 500° C. to 900° C., or 600° C. to 800° C.

From the viewpoint of production efficiency, the heating rate of the iron compound may be 20° C./h to 600° C./h, 40° C./h to 500° C./h, or 80° C./h to 400° C./h.

The iron compound is preferably calcined in such a manner that the heating time taken to reach a predetermined maximum calcination temperature is within the range of 15 minutes to ten hours. The holding time at the calcination temperature is five minutes or longer, preferably within the range of five minutes to 1000 hours, and more preferably within the range of ten minutes to 100 hours. In order to efficiently form the plate-shaped iron oxide particles, the holding time at the maximum calcination temperature is preferably two hours or longer, more preferably two hours to 48 hours, and further more preferably two hours to 24 hours.

Selecting conditions including a maximum calcination temperature of 400° C. or higher to lower than 1000° C. and a holding time of two hours to 48 hours at the maximum calcination temperature enables the plate-shaped iron oxide particles containing molybdenum to be readily obtained.

For example, the plate-shaped iron oxide particles with a high aspect ratio and with a small particle size can be readily obtained by using the particles of the iron compound obtained in the precursor producing step as the iron compound and selecting conditions including a calcination temperature of 400° C. or higher to lower than 1000° C. and a holding time of two hours to 48 hours at the calcination temperature.

A calcination atmosphere is not particularly limited and may be such that an effect of the present invention is obtained. The calcination atmosphere is preferably, for example, an oxygen-containing atmosphere such as an air or oxygen atmosphere or an inert atmosphere such as a nitrogen, argon, or carbon dioxide atmosphere and more preferably an air atmosphere in consideration of costs.

An apparatus for calcining the iron compound is not particularly limited and may be a so-called calcination furnace. The calcination furnace is preferably made of material not reactive with sublimated molybdenum oxide and is preferably highly hermetic such that molybdenum oxide is efficiently used.

### [Molybdenum-Removing Step]

The method for producing the plate-shaped iron oxide particles may further include a molybdenum-removing step of removing at least one portion of molybdenum after the calcination step as required.

Since molybdenum sublimates during calcination as described above, controlling the calcination temperature, the calcination time, or the like enables the content of molybdenum oxide in the surface layer of each plate-shaped iron oxide particle and also enables the content of molybdenum in a portion (an inner layer) other than the surface layer of the plate-shaped iron oxide particle and the state of molybdenum to be controlled.

Molybdenum can adhere to the surface of the plate-shaped iron oxide particle. The molybdenum can be removed by washing with water, an aqueous solution of ammonia, an aqueous solution of sodium hydroxide, an acidic aqueous solution, and the like as a means other than the sublimation.

In this process, the content of molybdenum in the plate-shaped iron oxide particles can be controlled by appropriately varying the amount of water used, the aqueous solution of ammonia, the aqueous solution of sodium hydroxide, or the acidic aqueous solution; the concentration of the aqueous solution of ammonia, the aqueous solution of sodium hydroxide, or the acidic aqueous solution; a washed portion; the washing time; and the like.

### [Crushing Step]

A calcined product obtained through the calcination step does not meet the range of the particle size that is appropriate for intended applications in some cases because the plate-shaped iron oxide particles aggregate. Therefore, the plate-shaped iron oxide particles may be crushed as required so as to meet the appropriate range of the particle size.

A method for crushing the calcined product is not particularly limited and known crushing devices such as ball mills, jaw crushers, jet mills, disk mills, spectro mills, grinders, and mixer mills can be used to crush the calcined product.

### [Classification Step]

The calcined product including the plate-shaped iron oxide particles obtained in the calcination step may be classified as appropriate in order to adjust the range of particle size. The term “classification” refers to the operation of grouping particles depending on the size of the particles.

While classification may be performed in either a wet or dry mode, dry classification is preferable from the viewpoint of production efficiency. Examples of dry classification include classification by sieving and pneumatic classification in which classification is performed by the difference between the centrifugal force and the fluid drag. Pneumatic classification is preferable from the viewpoint of classification precision and can be performed using a classifier, such as an air classifier, a spiral air classifier, a forced vortex centrifugal classifier, or a quasi-free vortex centrifugal classifier, using the Coanda effect.

The above-mentioned crushing step and classification step can be performed in a necessary stage. For example, the average particle size of the obtained plate-shaped iron oxide particles can be adjusted by whether the crushing and classification steps are performed or by selecting conditions of the crushing and classification steps.

The plate-shaped iron oxide particles according to an embodiment or plate-shaped iron oxide particles obtained by the production method according to an embodiment are preferably unlikely to aggregate or preferably do not aggregate from the viewpoint that inherent properties are likely to be exhibited, the handleability thereof is more excellent, and the dispersibility is more excellent when the iron oxide particles are used in such a manner that the iron oxide particles are dispersed in a dispersion medium.

The foregoing method for producing plate-shaped iron oxide particles is advantageous in that plate-shaped iron oxide particles having excellent properties of interest can be produced with high productivity without performing the crushing step or the classification step, because plate-shaped iron oxide particles that are unlikely to aggregate or do not aggregate can be readily produced.

### EXAMPLES

The present invention is further described below in detail with reference to examples. The present invention is not limited to the examples.

### Synthesis Example 1

### —Synthesis of Precursor-1

In a 2 L four-neck flask, 600 g of ion exchange water was poured, and the pH of the solution was adjusted to 2.8 using a 1M HCl solution, and the solution was heated to 75° C. with stirring at 200 rpm. To this four-neck flask, 60 g of a 10% by mass aqueous solution of Na₂MoO₄·2H₂O (available from FUJIFILM Wako Pure Chemical Corporation) was added at an instillation rate of 1 g/min, and 26.4 g of a 13.7% by mass aqueous solution of FeCl₃·6H₂O (available from FUJIFILM Wako Pure Chemical Corporation) was added at an instillation rate of 0.44 g/min, through different necks over one hour. After instillation, stirring at 75° C. was continued for one hour. To this four-neck flask, 418.8 g of a 13.7% by mass aqueous solution of FeCl₃·6H₂O was instilled at an instillation rate of 4.65 g/min and 430 g of a 5% by mass aqueous solution of NaOH was instilled through different necks over 1.5 hours such that the pH of the solution was kept at 2.8. After instillation, stirring at 75° C. was continued for three hours. After three hours, fine particles produced in the flask were recovered by filtration and dried at 110° C. for 15 hours to obtain 23.5 g of a mixture of fine particles of Fe₂O₃ and MoO₃ (precursor-1).

### Example 1

The obtained mixture of fine particles of Fe₂O₃ and MoO₃ (precursor-1) in an amount of 7 g was mixed with 0.29 g of R-972 (hydrophobic fumed silica, SiO₂ content of 99.8% by mass, available from NIPPON AEROSIL CO., LTD.) and 1.04 g of Na₂CO₃ (available from FUJIFILM Wako Pure Chemical Corporation), and the mixture was charged into a crucible. The crucible was heated to 600° C. at a heating rate of 5° C. per minute and held at 600° C. for five hours for calcination. Subsequently, the crucible was cooled at a cooling rate of 3° C. per minute to obtain 7.23 g of Fe₂O₃. The obtained Fe₂O₃ was put into 40 g of a 2.5% acetic acid aqueous solution, and the solution was stirred for 30 minutes. Subsequently, the acetic acid aqueous solution was removed by centrifugal separation. To the resultant sediment, 40 g of a 2% aqueous solution of ammonia was added and stirred for 30 minutes. Subsequently, the aqueous solution of ammonia was removed by centrifugal separation. To the resultant sediment, 40 g of ion exchange water was charged and stirred for 30 minutes, and ion exchange water was removed by centrifugal separation. To the resultant sediment, 40 g of ion exchange water was further charged and stirred for 30 minutes, and washing was performed to remove ion exchange water by centrifugal separation. The resultant sediment was dried at 110° C. for six hours to obtain 5.63 g of Fe₂O₃ powder of Example 1.

### Example 2

A method similar to that of Example 1 was performed except that the amount of Na₂CO₃ used was 1.25 g, and 5.51 g of Fe₂O₃ powder of Example 2 was obtained.

### Example 3

A method similar to that of Example 1 was performed except that the amount of Na₂CO₃ used was 1.67 g, and 5.59 g of Fe₂O₃ powder of Example 3 was obtained.

### Reference Example 1

In a mortar, 10 g of iron oxide (Fe₂O₃, a reagent available from Kanto Chemical Co., Inc.), 5.8 g of molybdenum trioxide (MoO₃, a reagent available from Taiyo Koko Co., Ltd.), 6 g of sodium carbonate (Na₂CO₃, a reagent available from Kanto Chemical Co., Inc.), and 0.5 g of silicon dioxide (SiO₂, a reagent available from Kanto Chemical Co., Inc.) were mixed together, whereby a mixture was obtained. The obtained mixture was put into a crucible and was calcined at 1100° C. for ten hours in a ceramic electric furnace. After cooling, the obtained solid was taken out of the crucible, whereby 22 g of black powder was obtained. The method of washing this powder was performed in the same manner as in Example 1 to obtain powder of Reference Example 1.

### [Evaluation]

The washed powders of Examples 1 to 3 and Reference Example 1 were evaluated as sample powders in the following manner.

### [Measurement of Particle Size Distribution]

For Examples 1 to 3, the particle size distribution was measured in a wet mode using water as a dispersion medium using a dynamic light scattering particle size measurement apparatus (NANOTRAC WAVE II available from MicrotracBEL Corporation). The particle size at a point where the cumulative volume percentage distribution curve intersects with the horizontal axis at 10% from the smallest particles was obtained as D₁₀, the particle size at a point where the distribution curve intersects with the horizontal axis at 50% was obtained as D₅₀, and the particle size at a point where the distribution curve intersects with the horizontal axis at 90% from the smallest particles was obtained as D₉₀.

For Reference Example 1, the particle size distribution of the sample powder was measured in a dry mode under conditions including a dispersive pressure of 3 bar and a suction pressure of 90 mbar using a laser diffraction dry-mode particle size distribution analyzer (HELOS (H3355) & RODOS available from Japan Laser Corporation). The particle size at a point where the cumulative volume percentage distribution curve intersects with the horizontal axis at 10% from the smallest particles was obtained as D₁₀, the particle size at a point where the distribution curve intersects with the horizontal axis at 50% was obtained as D₅₀, and the particle size at a point where the distribution curve intersects with the horizontal axis at 90% from the smallest particles was obtained as D₉₀.

### [Measurement of Average Particle Size of Primary Particles of Iron Oxide Particles]

A sample powder was photographed with a scanning electron microscope (SEM), the smallest unit particles (that is, the primary particles) forming agglomerates on a two-dimensional image were measured for the distance between two points on the contour, and the average of the maximum lengths of the distances of randomly selected 50 primary particles was determined as the average particle size of the iron oxide particles.

### [Measurement of Thickness of Iron Oxide Particles]

The thicknesses of 50 primary particles of iron oxide particles were measured using a scanning electron microscope (SEM) and the average of the measured thicknesses was determined as the thickness.

### [Aspect Ratio]

The aspect ratio was determined by the following equation.

Aspect ratio=Average particle size of iron oxide particles/Thickness of iron oxide particles

### [Measurement of Specific Surface Area of Iron Oxide Particles]

The iron oxide particles were measured for specific surface area using a specific surface area analyzer (BELSORP-mini available from MicrotracBEL Corporation). The surface area per gram of a measured sample was calculated from the amount of adsorbed nitrogen by the BET method as a specific surface area (m²/g).

### [Crystal Structure Analysis: X-Ray Diffraction (XRD) Method]

A sample powder was filled in a 0.5 mm deep holder for measurement samples, the holder was set to a wide-angle X-ray diffraction (XRD) instrument (Ultima IV, available from Rigaku Corporation), and the sample was measured under conditions including Cu Kα radiation, 40 kV/40 mA, a scanning speed of 2 degrees/min, and a scanning range of 10° to 70°.

### [X-Ray Fluorescence (XRF) Analysis]

About 70 mg of a sample powder was taken on a sheet of filter paper, was covered with a PP film, and was subjected to X-Ray fluorescence (XRF) analysis under conditions below using an X-ray fluorescence analyzer, Primus IV (available from Rigaku Corporation).

### Measurement Conditions

### EZ Scan Mode

Measurement elements: F to U
Measurement time: standard
Measurement diameter: 10 mm
Residue (balance component): not present

The Fe₂O₃ content (F₁) of the iron oxide particles, the MoO₃ (M₁) content of the iron oxide particles, and the SiO₂ content (S₁) of the iron oxide particles were determined by the XRF analysis.

### [XPS Surface Analysis]

The sample powder was analyzed for surface element using QUANTERA SXM available from Ulvac-Phi Inc with monochromatized Al Kα as an X-ray source, and X-ray photoelectron spectroscopy (XPS) was performed. In area measurement of 1000 μm square, the average value of measurements with n=3 was obtained in atomic percent for each element.

The iron content in the surface layer, the molybdenum content in the surface layer, and the silicon content in the surface layer of the iron oxide particle obtained by the XPS analysis were converted into the contents of oxides, whereby the Fe₂O₃ content (F₂) (% by mass) of the surface layer of each iron oxide particle, the MoO₃ content (M₂) (% by mass) of the surface layer of each iron oxide particle, and the SiO₂ content (S₂) of the surface layer of each iron oxide particle were determined.

### [Dispersibility of Iron Oxide Particles]

A dispersion liquid was prepared by dispersing 0.01 parts by mass of the iron oxide particles of Examples and Reference Example in 100 parts by mass of water, and the dispersibility of the particles was evaluated according to the following criteria.

A: Sedimentation of iron oxide particles was not found at a point of time 24 hours after preparation of the dispersion liquid.

B: Sedimentation of iron oxide particles was found at a point of time 24 hours after preparation of the dispersion liquid.

### [Results]

The values obtained by the evaluation are listed in Table 1.

TABLE 1

| | | | | Example | Example | Example | Reference |
|---|---|---|---|---|---|---|---|
| | | | | 1 | 2 | 3 | Example 1 |
| Production | | Precursor-1 (Fe₂O₃, MoO₃) | g | 7 | 7 | 7 | — |
| conditions | | Fe₂O₃ | g | — | — | — | 10 |
| | | MoO₃ | g | — | — | — | 5.8 |
| | | Fumed silica R-972 | g | 0.29 | 0.29 | 0.29 | — |
| | | SiO₂ | g | — | — | — | 0.5 |
| | | Na₂CO₃ | g | 1.04 | 1.25 | 1.67 | 6 |
| | | Fe/Mo | Molar | 9.3 | 9.3 | 9.3 | 1.6 |
| | | | ratio | | | | |
| | | SiO₂ parts by mass per 100 | Parts by | 5 | 5 | 5 | 5 |
| | | parts by mass of Fe₂O₃ | mass | | | | |
| | | Ratio of Na₂CO₃ to MoO₃ | Mole | 1.24 | 1.5 | 2 | 1.4 |
| | | (parts by mole) | | | | | |
| | | Calcination temperature | ° C. | 600 | 600 | 600 | 1100 |
| | | Calcination time | h | 5 | 5 | 5 | 10 |
| Evaluation | Shape | D₁₀ | μm | 0.18 | 0.15 | 0.17 | 2.00 |
| | and size | D₅₀ | μm | 0.42 | 0.29 | 0.31 | 1.30 |
| | | D₉₀ | μm | 0.63 | 0.42 | 0.47 | 10.50 |
| | | Average particle size | nm | 300 | 200 | 200 | 5000 |
| | | Thickness | nm | 7 | 6 | 5 | 2000 |
| | | Aspect ratio | | 42.9 | 33.3 | 40.0 | 2.5 |
| | Specific | BET method | m²/g | 16.6 | 33.1 | 48.5 | 0.3 |
| | surface | | | | | | |
| | area | | | | | | |
| | XRF | Fe₂O₃ (F₁) | mass % | 89.6 | 91.7 | 94.0 | — |
| | | MoO₃ (M₁) | mass % | 1.6 | 1.1 | 0.7 | — |
| | | SiO₂ (S₁) | mass % | 4.3 | 3.8 | 2.9 | — |
| | XPS | Fe₂O₃ (F₂) | mass % | 73.5 | 85.8 | 87.0 | — |
| | | MoO₃ (M₂) | mass % | 6.4 | 3.6 | 1.3 | — |
| | | SiO₂ (S₂) | mass % | 12.2 | 6.9 | 6.9 | — |

| | | | | |
|---|---|---|---|---|
| MoO₃ surface uneven distribution ratio | 4.0 | 3.3 | 1.9 | — |
| (M₂/M₁) | | | | |
| SiO₂ surface uneven distribution ratio | 2.8 | 1.8 | 2.4 | — |
| (S₂/S₁) | | | | |
| Dispersibility | A | A | A | B |

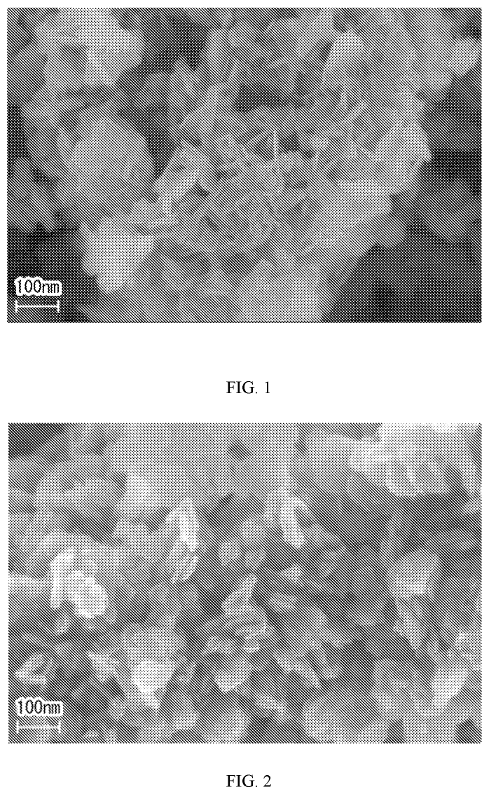

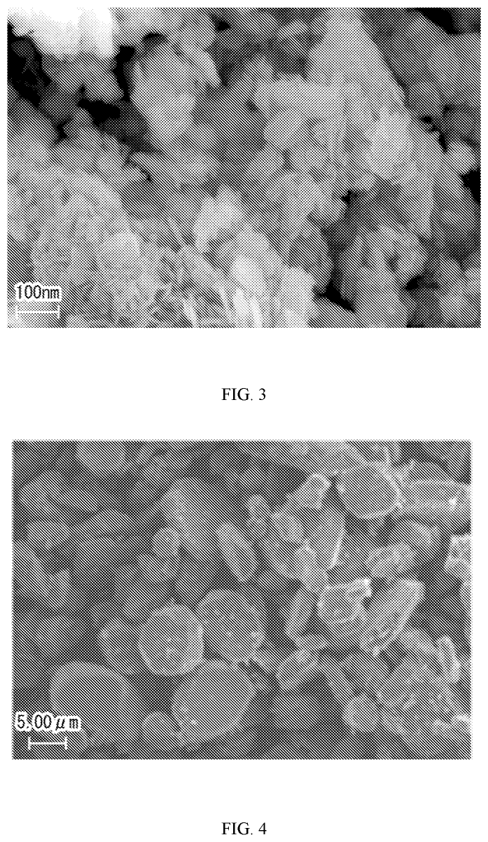

FIGS. 1 to 3 are SEM images of the powders of Examples 1 to 3 photographed by a scanning electron microscope (SEM). FIG. 4 is a SEM image of the powder of Reference Example 1.

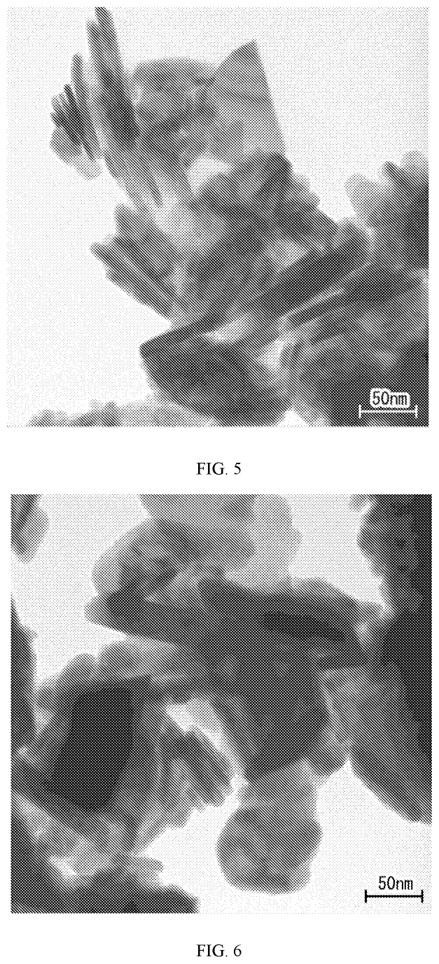

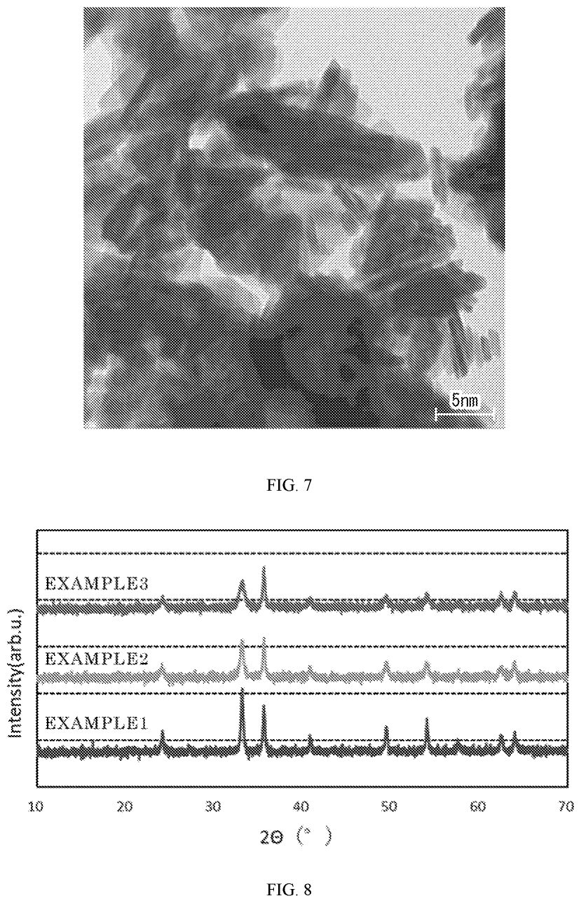

FIGS. 5 to 7 are TEM images of the powders of Examples 1 to 3 photographed by a transmission electron microscope (TEM).

The presence of nanosized plate-shaped particles was observed in each of Examples 1 to 3.

FIG. 8 indicates the results of the XRD analysis. The diffraction peak of the [110] plane of hematite (α-Fe₂O₃) was observed at a 2θ angle of about 35.6°. The diffraction peak of the [104] plane of hematite (α-Fe₂O₃) was observed at a 20 angle of about 33.2°. The diffraction peak of the [012] plane of hematite (α-Fe₂O₃) was observed at a 20 angle of about 24.1°.

The results of the SEM observation, the TEM observation, and the XRD analysis demonstrate that the powders obtained in Examples are plate-shaped iron oxide particles containing iron oxide.

The results of Examples demonstrate that plate-shaped iron oxide particles can be produced by calcination at a relatively low temperature of 600° C.

By using the precursor-1 synthesized as described above as the iron compound and the molybdenum compound, the nanosized plate-shaped iron oxide particles having the D₅₀, average particle size, thickness, and aspect ratio as listed in Table 1 were obtained. It is conceivable that the precursor-1 contained nanosized Fe₂O₃ particles and nanosized MoO₃, and this precursor-1 was used as a raw material to be calcined, whereby plate-shaped iron oxide particles with a high aspect ratio and with a small particle size were readily produced.

The values of the Fe₂O₃ content (F₁), the MoO₃ content (M₁), SiO₂ content (S₁), the Fe₂O₃ content (F₂), the MoO₃ content (M₂), and the SiO₂ content (S₂) are listed in Table 1.

Based on the results of the MoO₃ content (M₁) and the MoO₃ content (M₂), the plate-shaped iron oxide particles of Examples 1 to 3 contain molybdenum on its surface, and it can be expected that various actions by molybdenum, such as catalytic activity, are fulfilled.

The calculation results of the surface uneven distribution ratio (M₂/M₁) of the MoO₃ content (M₂) to the MoO₃ content (M₁) and the surface uneven distribution ratio (S₂/S₁) of the SiO₂ content (S₂) to the SiO₂ content (S₁) are also listed in Table 1.

The results of the surface uneven distribution ratio (M₂/M₁) demonstrate that, in the plate-shaped iron oxide particles of Examples 1 to 3, the molybdenum oxide content in the surface layer of each plate-shaped iron oxide particle as determined by the XPS surface analysis is higher than the molybdenum oxide content as determined by the XRF analysis. Based on this, it was confirmed that molybdenum is unevenly distributed in the surface of each plate-shaped iron oxide particle and it can be expected that various actions by molybdenum are effectively fulfilled.

The results of the surface uneven distribution ratio (S₂/S₁) demonstrate that, in the plate-shaped iron oxide particles of Examples 1 to 3, the silica content in the surface layer of each plate-shaped iron oxide particle as determined by the XPS surface analysis is higher than the silica content as determined by the XRF analysis. Based on this, it is confirmed that silicon is unevenly distributed in the surface of each plate-shaped iron oxide particle, and it can be expected that improvement in dispersibility in water by silicon is effectively fulfilled.

It was also confirmed that the powders obtained in Examples 1 to 3 and Reference Example 1 had BET specific surface areas listed in Table 1.

The dispersibility of the iron oxide particles of Examples and Reference Example was evaluated. In the iron oxide particles of Reference Example 1, sedimentation of particles was found (dispersibility B), whereas in the plate-shaped iron oxide particles of Examples 1 to 3, noticeable sedimentation of particles was not found (dispersibility A) and the dispersibility was excellent.

This is presumably because the plate-shaped iron oxide particles of Examples 1 to 3 have a much smaller particle size, have a higher aspect ratio, and a larger BET specific surface area than the iron oxide particles of Reference Example 1.

The configurations and combinations thereof in the embodiments are illustrated by way of example. Addition, elimination, replacement, and other modifications can be made without departing from the spirit of the invention. The present invention is not limited by the embodiments and is limited only by the scope of the claims.

1. Plate-shaped iron oxide particles comprising molybdenum and atoms derived from a shape control agent.

2. The plate-shaped iron oxide particles according to claim 1, wherein the plate-shaped iron oxide particles have a median diameter D₅₀ of 0.01 μm to 0.5 μm as determined by a dynamic light scattering method.

3. The plate-shaped iron oxide particles according to claim 1, wherein an aspect ratio obtained by dividing an average particle size of primary particles by a thickness thereof is 5 to 500.

4. The plate-shaped iron oxide particles according to claim 3, wherein the primary particles have an average particle size of 0.01 μm to 0.5 μm and a thickness of less than 0.05 km.

5. The plate-shaped iron oxide particles according tow claim 1, wherein a Fe₂O₃ content (F₁) of the plate-shaped iron oxide particles is 85.0% by mass to 99.5% by mass as determined by X-ray fluorescence (XRF) analysis of the plate-shaped iron oxide particles, and a MoO₃ content (M₁) of the plate-shaped iron oxide particles is 0.01% by mass to 5.0% by mass as determined by XRF analysis of the plate-shaped iron oxide particles.

6. The plate-shaped iron oxide particles according to claim 1, wherein the atoms derived from a shape control agent are at least one kind selected from the group consisting of silicon, germanium, and phosphorus.

7. The plate-shaped iron oxide particles according to claim 1, wherein the atoms derived from a shape control agent are unevenly distributed in a surface layer of each of the plate-shaped iron oxide particles.

8. The plate-shaped iron oxide particles according to claim 1, wherein the atoms derived from a shape control agent are silicon.

9. The plate-shaped iron oxide particles according to claim 8, wherein a Fe₂O₃ content (F₁) of the plate-shaped iron oxide particles is 85.0% by mass to 99.5% by mass as determined by X-ray fluorescence (XRF) analysis of the plate-shaped iron oxide particles, a MoO₃ content (M₁) of the plate-shaped iron oxide particles is 0.01% by mass to 5.0% by mass as determined by XRF analysis of the plate-shaped iron oxide particles, and a SiO₂ content (S₁) of the plate-shaped iron oxide particles is 0.001% by mass to 10% by mass as determined by XRF analysis of the plate-shaped iron oxide particles.

10. The plate-shaped iron oxide particles according to claim 8, wherein a surface uneven distribution ratio (S₂/S₁) of a SiO₂ content (S₂) of a surface layer of each of the plate-shaped iron oxide particles as determined by X-ray photoelectron spectroscopy (XPS) surface analysis of the plate-shaped iron oxide particle to a SiO₂ content (S₁) of the plate-shaped iron oxide particle as determined by X-ray fluorescence (XRF) analysis of the plate-shaped iron oxide particle is more than 1 and 20 or less.

11. The plate-shaped iron oxide particles according to claim 1, wherein the plate-shaped iron oxide particles have a specific surface area of 0.5 m²/g or more as determined by a BET method.

12. A method for producing the plate-shaped iron oxide particles according to claim 1, the method comprising a calcination step of calcining an iron compound in presence of a molybdenum compound and a shape control agent.

13. The method for producing the plate-shaped iron oxide particles according to claim 12, wherein the shape control agent is silicon or a silicon compound.

14. The method for producing the plate-shaped iron oxide particles according to claim 12, comprising a precursor producing step of obtaining nanosized particles of the iron compound, prior to the calcination step.

15. The method for producing the plate-shaped iron oxide particles according to claim 12, wherein the molybdenum compound in the calcination step is at least one kind selected from the group consisting of molybdenum trioxide, lithium molybdate, potassium molybdate, and sodium molybdate.

16. The method for producing the plate-shaped iron oxide particles according to claim 12, wherein the iron compound is calcined at a calcination temperature of 400° C. or higher and lower than 1000° C.
